(19) United States
(12) Patent Application Publication
(10) Pub. No.: US 2002/0024015 A1
(43) Pub. Date: Feb. 28, 2002

(54) Device and method for the excitation of fluorescent labels and scanning microscope

(76) Inventors: Juergen Hoffmann, Wiesbaden (DE); Werner Knebel, Kronau (DE)

Correspondence Address: Glenn Law, FOLEY & LARDNER, Washington Harbour, 3000 K Street, N.W., Suite 500, Washington, DC, 20007-5109, US

(21) Appl. No.: 09/928,501

(22) Filed: Aug. 14, 2001

(30) Foreign Application Priority Data
Aug. 31, 2000 (DE) DE 100 42 840.1

(51) Int. Cl. G21K 7/00; G01N 23/00

(52) U.S. Cl. 250/311

(57) ABSTRACT

The present invention relates to a device and to a method for the excitation of fluorescent markers in multiphoton scanning microscopy, having at least one illumination beam path, a light source that produces the illumination light and at least one detection beam path for a detector, the objects to be studied being labelled with fluorescent markers. So as to avoid making it necessary to increase the illumination power of the light source in order to achieve an increase in the fluorescence photon yield, the device according to the invention and the method according to the invention are characterized in that at least one means that influences the spectral distribution/composition of the illumination light is provided for variably influencing the illumination light that excites the fluorescent markers, in particular during the illumination process.

### CROSS REFERENCE TO RELATED APPLICATIONS

This invention claims priority of the German patent application 100 42 840.1 which is incorporated by reference herein.

### FIELD OF THE INVENTION

The present invention relates to a device and to a method for the excitation of fluorescent markers in multiphoton scanning microscopy, having at least one illumination beam path, a light source that produces the illumination light and at least one detection beam path for a detector, the objects to be studied being labelled with fluorescent markers.

### BACKGROUND OF THE INVENTION

Devices of the generic type have been known for a considerable time in practice and, merely by way of example, reference may be made to the article “Two-Photon Molecular Excitation in Laser-Scanning Microscopy” by W. Denk, D. W. Piston and W. W. Web, in: Handbook of Biological Confocal Microscopy, ed.: J. B. Pawley, 1995, pages 445 to 458. This article gives an extensive overview of the possibilities and advantages of multiphoton scanning microscopy. In multiphoton scanning microscopy, fluorescent markers are excited by two-photon or multiphoton excitation processes. For example, the probability of a three-photon transition depends on the third power of the excitation light power. Such high light powers can be achieved, for example, with pulsed light sources, but the light pulses then have a pulse period which is in the picosecond or femtosecond range.

The excitation of fluorescent markers by light from the light source is usually carried out by illuminating the object with a light beam focused by the microscope objective in a spot. It is likewise customary to illuminate the object with a plurality of spots, as mentioned for example in EP 0 539 691 A1.

In principle, light pulses always consist of light at a plurality of wavelengths. For example, phase-locked superposition of light at a plurality of wavelengths in a laser leads to pulse formation. When the number of superposed components is high, the resulting pulse emitted by the light source is commensurately shorter.

If light components with one wavelength in a laser pulse temporally run ahead of the light components with another wavelength, then the pulse is a “chirped” pulse. When the low-frequency components of a pulse run ahead, the chirp is positive, whereas the chirp is conversely negative when high-frequency components run ahead.

The light pulses originating from commercially available laser systems are generally unchirped, in particular when laser light from a mode-locked pulse laser is involved. Mode-locked pulse lasers achieve a short pulse period only if elements internal to the resonator are provided for group-velocity dispersion compensation, which have precisely the effect of preventing a chirp.

DE 196 22 359 A1 and DE 198 33 025 A1 respectively disclose optical arrangements which are used for the transmission of short laser pulses in optical fibers. These optical arrangements compensate for the group-velocity dispersion (GVD) caused by the glass fiber, so that light pulses which have a pulse shape that substantially corresponds to the pulse shape emitted by the laser are applied to the fluorescent markers to be excited. In these arrangements, the reason given for the GVD compensation is to maximize the pulse light power that stimulates the multiphoton fluorescence, since the maximum pulse light power of a light pulse in the focus region of a scanning microscope is commensurately higher for a given average light power if the light pulse is temporally shorter. The fluorescence photon yield, however, cannot be increased arbitrarily by increasing the output light power of the light source. Above a saturation intensity, which generally depends on the sample or the fluorescent markers, all the excitable fluorescent markers are in the excited state so that a laser pulse with higher power does not achieve any increase in the fluorescence photon yield, but rather causes thermal damage to the object to be studied.

### SUMMARY OF THE INVENTION

It is therefore an object of the present invention to provide a device for the excitation of fluorescent markers in multiphoton scanning microscopy which avoids making it necessary to increase the illumination power of the light source in order to achieve an increase in the fluorescence photon yield.

The aforesaid object is achieved by a device comprising: a light source which defines an illumination beam path and which produces illumination light having short light pulses and a chirp, a detector receiving light from an object being labelled with fluorescent markers, a means for varying the chirp of the illumination light, whereby the means for varying the chirp of the illumination light is arranged in the illumination beam path.

It is an other object of the invention to create a scanning microscope which makes possible to increase the fluorescence photon yield by avoiding an increased illumination power.

The aforesaid object is achieved by a A Scanning microscope comprising: a light source which defines an illumination beam path and which produces illumination light having short light pulses, whereby the illumination light is directed onto an object being labelled with fluorescent markers, a detector receiving light from the object, a means for varying the chirp of the illumination light, whereby the means for varying the chirp of the illumination light is arranged in the illumination beam path.

It is a further object of the invention to provide a method for the excitation of fluorescent markers which avoids making it necessary to increase the illumination power of the light source in order to achieve an increase in the fluorescence photon yield.

The aforesaid object is achieved by a comprising the steps of: generating with a light source an illumination light having short light pulses and a chirp, wherein the illumination light defines an illumination beam path, selecting a chirp and adjusting the selected chirp with means for varying the chirp of the illumination light, whereby the means for varying the chirp of the illumination light is arranged in the illumination beam path and directing the illumination light on an object being labelled with fluorescent markers.

According to the invention, it has been recognized that the fluorescence yield not only depends on the light power of an excitation pulse but can also be optimized, through optimum chirp matching to the absorption behaviour of the fluorescent markers, even with the same light power. It has furthermore been recognized that fluorescent markers have a different excitation response when the immediate environment of the fluorescent markers changes. Hence, by influencing the spectral distribution/composition of the illumination light according to the invention, on the one hand the fluorescence signal yield can be optimized or matched in terms of the respective ambient properties and, on the other hand, with the aid of suitable measurements using illumination light with different spectral distribution/composition, information can be derived about the immediate environment of the fluorescent markers.

The influencing of the spectral distribution/composition of the illumination light, or the chirp of the light pulses, according to the invention, is preferably carried out during the illumination process, i.e. during the process of detecting the objects to be studied. In this case, the influencing of the spectral distribution/composition could take place variably, i.e. it is changed during the illumination/detection process.

In contrast to the procedure of providing means for influencing the illumination light in such a way that these means merely compensate for a pulse-shape change of the light pulses, which is caused by the transmission of the light through a fiber or another optical element of the microscope, the invention proposes to induce deliberate changes in the spectral distribution/composition of the illumination light so as, for example, to increase the fluorescence photon yield thereby.

It is particularly advantageous if the influencing according to the invention is variably configured, i.e. a plurality of influencing processes are carried out or applied during the object detection, so that different signal responses can thereby be measured, where appropriate, as a function of the respective influencing.

In a preferred embodiment, the light source is a multiphoton light source, which is to say a light source suitable for multiphoton excitation. It emits individual pulses, or pulse trains, with high power so that the objects which have been labelled with fluorescent markers and are introduced into a multiphoton scanning microscope, can be excited to fluorescence via a multiphoton excitation process. In practical terms, the multiphoton light source is a titanium:sapphire laser which, for example, is pumped by an argon-ion laser. It is also conceivable to employ an OPO (optical parametric oscillator), but in general any laser light source with suitable wavelengths and sufficient excitation power can be used.

In another embodiment, the means for variably influencing the illumination light is arranged in the illumination beam path. For example, the means may be arranged between the light source and the object, although it is preferable to arrange the means in a beam-path section which comprises only the illumination light but not the detection light.

The means for variably influencing the illumination light preferably influences the chirp. In this case, provision may be made for a positive chirp and/or a negative chirp to be imposed on the light pulses if these leave the light source initially unchirped. Provision is also made to influence chirped pulses leaving the laser light source.

An alternative embodiment of the variable influencing of the illumination light could be achieved if the means originally provided for dispersion compensation in mode-locked lasers is used for influencing the illumination light. In this case, the existing means is used for influencing the illumination light from the laser light source, which very advantageously makes it unnecessary to use or insert extra optical components. Precautions merely need to be taken so that the dispersion compensation means of the mode-locked laser are driven, controlled or adjusted correspondingly.

A Gires-Tournois interferometer could also be provided as the influencing means. Furthermore, the influencing means could also be embodied as a material which has suitable dispersion and whose effective optical length is variable. This could, for example, involve a device known from DE 198 33 025 A1, that is to say, for example, two separately displaceable double wedges, the illumination light preferably passing orthogonally through the outer interfaces of the material in order to prevent any beam offset.

The influencing means could furthermore have at least one mirror which influences the chirp of the light pulse. Such a mirror consists of a substrate provided with a plurality of dielectric coatings, light with different wavelengths being capable of entering the dielectric layer to different depths before it is reflected.

As an alternative, at least one grating pair and/or prism pair could be provided as the influencing means. The illumination light is first spectrally spread by a first grating or prism and the spectrally spread illumination beam can be collimated by a suitably arranged second grating or prism. The spectral spreading produces, for the individual spectral components, optical path-length differences which are utilised for deliberate influencing of the spectral distribution/composition of the illumination light. In order to return the collimated illumination light beam to its original beam shape, a further grating and/or prism pair is provided which is arranged as the mirror image of the first grating and/or prism pair with respect to the propagation direction of the illumination light. The grating and/or prism pair preferably produces a negative group-velocity dispersion.

In an alternative embodiment, the means for influencing the illumination light is arranged between a grating pair and/or a prism pair. In this case, the illumination light is spectrally spread by a first grating or prism and passes through the means for influencing the illumination light. The influenced illumination light is returned to a collimated light beam by the second grating or prism.

Advantageously, the means is intended for spatial modulation of the light as a function of the position coordinates. In this way, a plurality of regions of the spectrally spread light, or merely one region, can be independently modulated or influenced.

The means for spatial modulation could be embodied as an LCD (liquid crystal device) element, in particular in the form of an LCD array or an LCD strip pattern, having a plurality of segments which can be driven or adjusted independently of one another. This LCD element can advantageously be driven in pixel or strip mode, so that individual spatial regions can be deliberately varied. The spatial modulation means is used to influence the phase, the intensity and/or the polarization of the light passing through the means. The spatial modulation means can particularly advantageously be controlled as a function of the detected fluorescent light. In particular, the control is used for optimizing the fluorescent-light yield. For practical driving of the spatial modulation means, provision is made for the use of genetic algorithms which achieve optimal adjustment of the spatial modulation means according to the genetic algorithm procedure.

In a preferred embodiment, a plurality of subsidiary illumination beam paths are provided, in each of which at least one means that influences the spectral distribution/composition of the illumination light is provided. Accordingly, the illumination beam path is split into at least two subsidiary beam paths. In a practical embodiment, a means for influencing the illumination light is provided in each of the subsidiary beam paths. For example, a prism pair could be provided in one subsidiary beam path for influencing the light passing through this subsidiary beam path, whereas a material with suitable dispersion, whose effective optical length is variable, is provided as the influencing means in another subsidiary beam path. Accordingly, the subsidiary illumination beam paths differently influence the light passing through the respective subsidiary illumination beam paths. Provision could also be made for one illumination beam path not to be influenced. The different subsidiary illumination beam paths are recombined at a suitable point by a beam splitter, so that the differently influenced illumination light can finally be used for the object illumination. In this case, the optical paths of the individual subsidiary illumination beam paths can be selected in such a way that, with an originally periodically recurring defined pulse train from the light source, there is a defined pulse train of the differently influenced pulses after the recombination of the subsidiary illumination beam paths. For specific applications, provision is made to select the individual subsidiary illumination beam paths, or a single subsidiary illumination beam path, so that the respective object is excited by light which has passed through one subsidiary beam path. Selection of the individual subsidiary illumination beam paths by a fast optical switch, for example in the form of acousto- or electro-optically active components, might also be conceivable. Each of these components would preferably be for use in one subsidiary illumination beam path or as a beam-combination component. In this case, the light of the subsidiary illumination beam paths can be selected mutually exclusively, i.e. illumination light which is respectively passed through only one subsidiary illumination beam path is in each case applied to the object.

In particular for analyzing the immediate environment of the fluorescent markers, provision is made for the fluorescent markers to be alternately excited by light pulses with a positive and a negative chirp. The production of these differently influenced light pulses could be carried out using an already described device, which has a plurality of subsidiary illumination beam paths which each differently influence the illumination light.

The fluorescent light excited by the light pulses with different chirps is detected either spatially and/or temporally separately from one another. To that end, a synchronization circuit is provided between the light source and the detector of the multiphoton scanning microscope, so that if the sequence of the differently influenced light pulses is known, corresponding allocation of the detection signals to different channels can take place on the detector side. The detected and separately registered fluorescence signals could thereupon be put into their ratio for further processing so that, for example, information about the properties of the environment of the fluorescent labels can be inferred.

### BRIEF DESCRIPTION OF THE DRAWINGS

Generally preferred configurations and developments of the teaching are furthermore explained in connection with the explanation of the preferred exemplary embodiments of the invention with the aid of the drawing. In the drawing,

FIG. 1 shows a diagrammatic representation of a first exemplary embodiment according to the invention,

FIG. 2 shows a diagrammatic representation of a second exemplary embodiment according to the invention,

FIG. 3 shows a diagrammatic representation of a third exemplary embodiment according to the invention, and

FIG. 4 shows a diagrammatic representation of an alternative exemplary embodiment to FIG. 3.

### DETAILED DESCRIPTION OF THE INVENTION

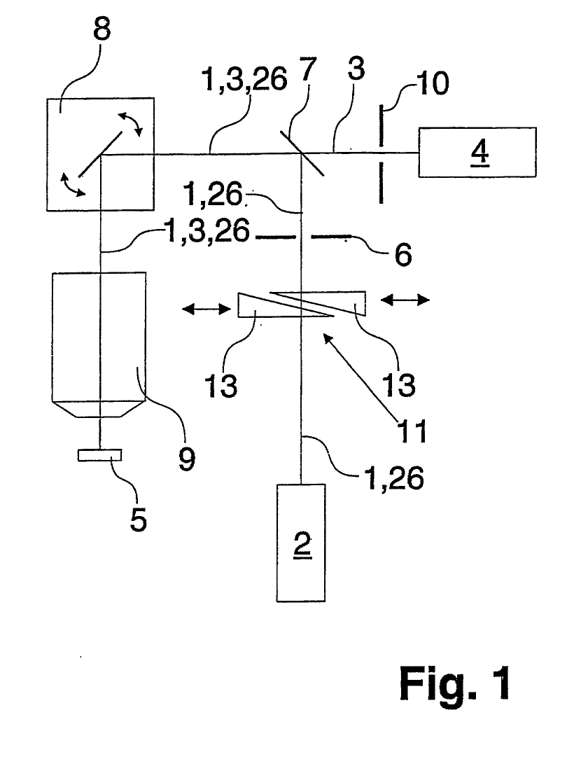

FIG. 1 shows a device for the excitation of fluorescent markers in multiphoton scanning microscopy, having an illumination beam path 1, a light source 2 that produces the illumination light 26 and a detection beam path 3 for a detector 4. The objects 5 to be studied are labelled with fluorescent markers.

The multiphoton scanning microscope is a confocal laser scanning microscope, the illumination light 26 passing through an excitation pinhole 6 and being reflected by a dichroic beam splitter 7 in the direction of a beam deflection device 8. The illumination light beam 1 is scanned by the beam deflection device 8 in two substantially mutually perpendicular directions, and is reflected in the direction of the microscope lens 9—represented merely diagrammatically. The beam deflection by the beam deflection device 8 takes place with the aid of a cardan-suspended mirror which can be rotated about two axes and deflects, or scans, the beam in the X direction and the Y direction.

The illumination light 26 is focused into or onto the object 5 by the microscope lens 9, the excitation pinhole 6 being arranged optically corresponding to the illumination focus of the microscope objective 9. The fluorescent light emitted by the object 5 travels along the illumination beam path 1 in reverse sequence, that is to say first through the microscope objective 9, then the beam deflection device 8 as far as the dichroic beam splitter 7.

The detection beam path 3 runs between the object 5 and the detector 4. The fluorescent light passes through the dichroic beam splitter 7. Between the beam splitter 7 and the detector 4, a detection pinhole 10 is arranged which optically corresponds to the illumination focus of the microscope objective 9 and to the excitation pinhole 6.

The use of a detection pinhole 10 is not compulsory in multiphoton scanning microscopy since, because of the nature of multiphoton fluorescence excitation, only at the illumination focus of the microscope objective is the light intensity high enough to induce multiphoton fluorescence excitation there with sufficiently high probability. Accordingly, the multiphoton excitation process provides depth-of-focus discrimination which, in the case of single-photon fluorescence excitation can be achieved only with the aid of a detection pinhole.

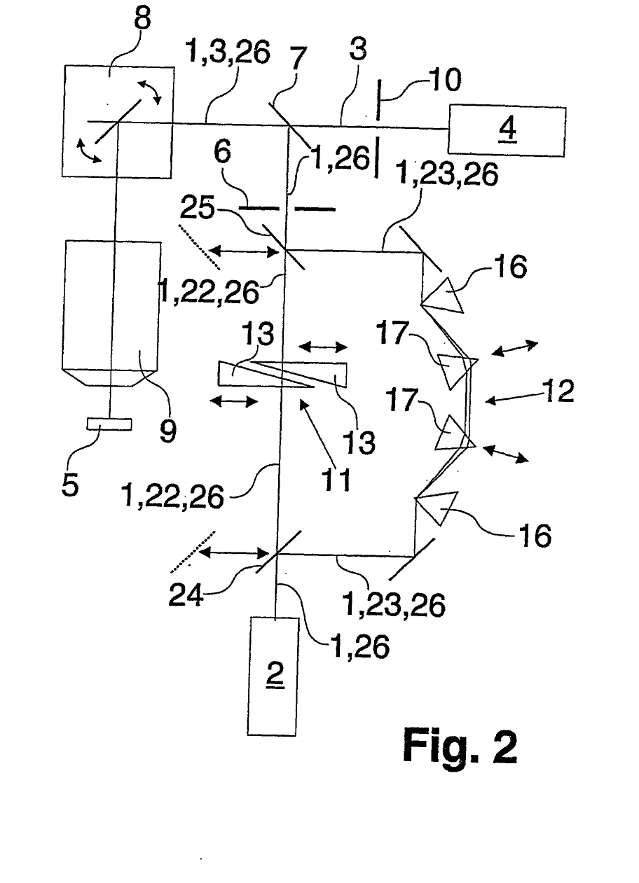

According to the invention, a means 11 that influences the spectral distribution/composition of the illumination light 26 is provided for variably influencing the illumination light 26 that excites the fluorescent labels during the illumination process. In FIG. 2, two different means 11, 12 for influencing the illumination light 26 are provided.

The light source 2 is a mode-locked titanium:sapphire laser, which is used as a multiphoton light source. The means 11 for influencing the illumination light 26 is arranged in the illumination beam path 1. The means 11 and/or 12 shown in FIGS. 1 and 2 influence the chirp of the illumination light 26.

The influencing means 11 of FIGS. 1 and 2 is embodied as a material with suitable dispersion, whose effective optical length is variable. The material is in this case embodied in the form of two mutually displaceable double wedges 13, which can be shifted transversely with respect to the propagation direction of the illumination light beam 26, so that the effective thickness of the material can thereby be varied. The gap between the two double wedges 13 merely serves for clear representation; to prevent spectral spreading of the illumination light beam 26, it is filled with an immersion medium which has almost the same refractive index and the same dispersion properties as the material of the means 11.

In FIG. 2, a prism pair 16, 17 is provided as the influencing means 12.

FIG. 2 shows that the illumination light beam 26 strikes a first prism 16 which spectrally spreads the illumination light beam 26. The spectrally spread light strikes a second prism 17, which collimates the spectrally spread illumination light beam. Two further prisms 17, 16 convert the illumination light beam 26 into its original shape. The illumination light 26 passing through the prism arrangement 16, 17 is changed in terms of its pulse shape and its spectral composition, since the longer-wave components of the light pulse go along a different optical path from the shorter-wave components of the pulse of the illumination light beam 26 that is spectrally spread in spatial fashion. The change in the pulse shape is in this case attributable to the paths travelled by the illumination light 26 in the prisms 17, since the light components spectrally spread by the prism 16 each travel a different distance in the prisms 17 and correspondingly have a different propagation velocity in the prisms, corresponding to their respective wavelength.

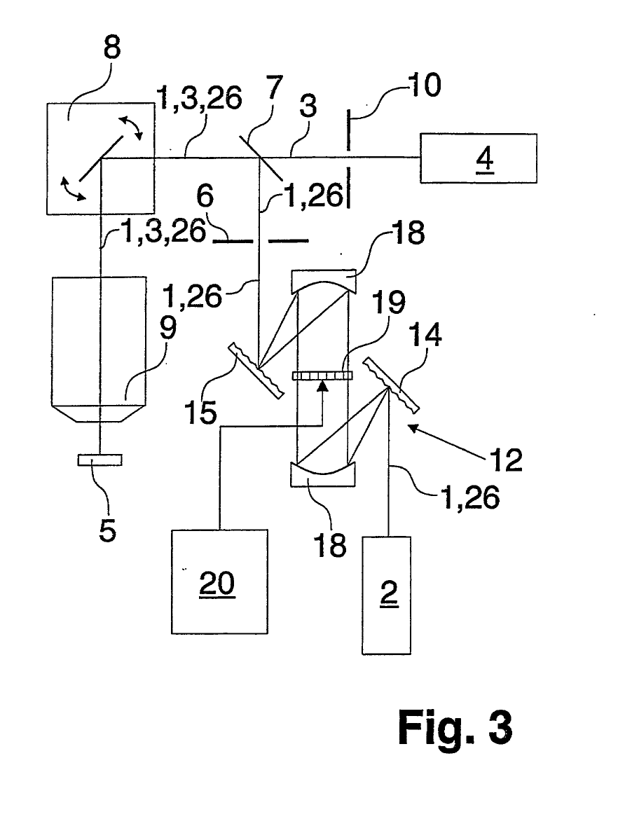

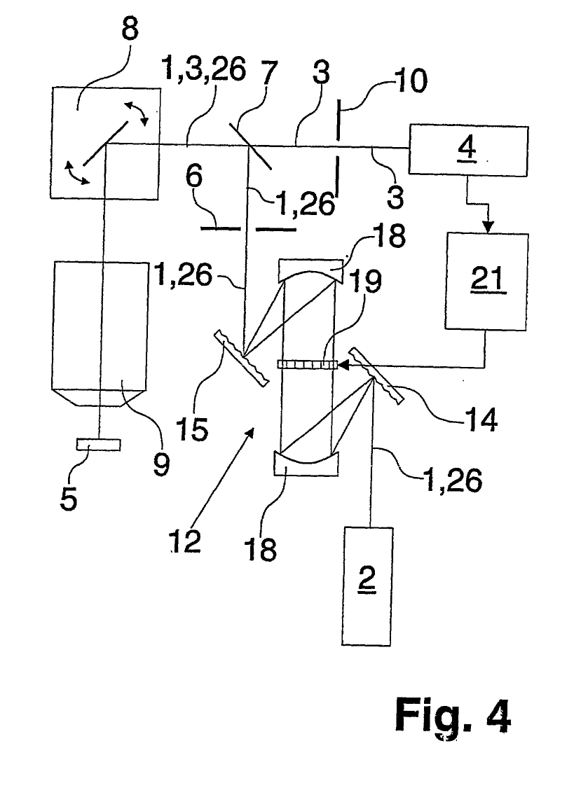

In FIGS. 3 and 4, the influencing means 19 is arranged between a grating pair 14, 15. The illumination light 26 is reflected and spectrally spread by the grating 14, which is embodied as a reflection grating. This light is collimated by the concave mirror 18, and is recombined by another concave mirror 18. The spectral spreading of the illumination light beam 26 is reversed by the grating 15, so that the illumination light beam 26 almost has the original beam shape after passing through the grating and concave mirror arrangement 14, 15, 18. Instead of using the two concave mirrors 18, plane mirrors in conjunction with focusing lenses can be used for comparable beam guiding of the illumination light beam section shown in FIGS. 3 and 4.

The spatial modulation means 19 is an LCD strip pattern, which influences the phase of the light 26 passing through the means 19. In the spectrally spread region, the means 19 causes modulation or influencing of the light as a function of the position coordinates, i.e. by deliberate changing of individual LCD strips. The LCD strip pattern 19 is driven with the aid of a drive unit 20.

FIG. 4 shows that the spatial modulation means 19 is controlled as a function of the power of the detected fluorescent light. To that end, in order to optimize the fluorescent-light yield, the detector 4 is connected to the control unit 21 of the means 19. The spatial modulation means 19 is then driven differently by the control unit 21 until the detector 4 detects a maximum fluorescent-light power. In this context, “differently” means that different combinations of the settings of the segments of the LCD strip pattern cause a different respective phase lag of the individual spectral components of the light pulses passing through the means 19.

FIG. 2 shows that a plurality of subsidiary illumination beam paths 22, 23 are provided, in each of which a means 11, 12 that influences the spectral distribution/composition of the illumination light 26 is provided. In the subsidiary illumination beam path 22, for instance, a means 11 is provided which consists of a material with suitable dispersion and is variable in terms of its effective optical length. Two prism pairs 16, 17, which influence the subsidiary illumination beam path 23, are provided in the subsidiary beam path 23. The two mirrors 24, 25 may—as shown in FIG. 2—be arranged in the illumination beam path 1. The illumination light 26 then travels along the subsidiary illumination beam path 23. If the two mirrors 24, 25 are set in the position shown by a broken line in FIG. 2, then the illumination light 26 from the light source 2 travels along the subsidiary illumination beam path 22. Accordingly, the subsidiary illumination beam paths 22, 23 can be selected mutually exclusively, i.e. the object 5 receives either the light which has travelled along the subsidiary illumination beam path 22 or light which has travelled along the subsidiary illumination beam path 23.

Lastly, it should more particularly be pointed out that the exemplary embodiments discussed above are merely used to describe the claimed teaching, but do not restrict it to the exemplary embodiments.

What is claimed is:

1. A device for the excitation of fluorescent markers in multiphoton scanning microscopy comprising:
a light source which defines an illumination beam path and which produces illumination light having short light pulses and a chirp, a detector receiving light from an object being labelled with fluorescent markers, a means for varying the chirp of the illumination light, whereby the means for varying the chirp of the illumination light is arranged in the illumination beam path.

2. Device according to claim 1, wherein the means provided for dispersion compensation in mode-locked lasers is used for influencing the illumination light.

3. Device according to claim 1, wherein the means for varying the chirp of the illumination light consists essentially of a Gires-Tournois interferometer.

4. Device according to claim 1, wherein the means for varying the chirp of the illumination light of the illumination light consists of a material having a dispersion and an optical length, wherein the optical length is variable.

5. Device according to claim 1, wherein the means for varying the chirp of the illumination light consists of mutually displaceable double wedges.

6. Device according to claim 1, wherein the means for varying the chirp of the illumination light has at least one dispersive mirror.

7. Device according to claim 1, wherein the means for varying the chirp of the illumination light includes at least one grating pair or at least one prism pair.

8. Device according to claim 1, wherein the means for varying the chirp of the illumination light has a negative or positive group-velocity dispersion.

9. Device according to claim 7, wherein the means for varying the chirp of the illumination light has a spatial modulation means which is arranged between the grating pair or between the prism pair and which varies the phase of the illumination light.

10. Device according to claim 9, wherein the spatial modulation means is embodied as an LCD (liquid crystal device) array or an LCD strip pattern.

11. Device according to claim 1, wherein the light source defines at least a second beam path having a second means for varying the chirp of the illumination light.

12. A Scanning microscope comprising:
a light source which defines an illumination beam path and which produces illumination light having short light pulses, whereby the illumination light is directed onto an object being labelled with fluorescent markers, a detector receiving light from the object, a means for varying the chirp of the illumination light, whereby the means for varying the chirp of the illumination light is arranged in the illumination beam path.

13. The Scanning microscope according to claim 12, wherein the means for varying the chirp of the illumination light of the illumination light consists of a material having a dispersion and an optical length, wherein the optical length is variable.

14. The Scanning microscope according to claim 12, wherein the means for varying the chirp of the illumination light includes at least one grating pair or at least one prism pair.

15. The Scanning optical microscope according to claim 14, wherein the means for varying the chirp of the illumination light has a spatial modulation means which is arranged between the grating pair or between the prism pair and which varies the phase of the illumination light.

16. A Method for the excitation of fluorescent markers comprising the steps of:
generating with a light source an illumination light having short light pulses and a chirp, wherein the illumination light defines an illumination beam path,
selecting a chirp and adjusting the selected chirp with means for varying the chirp of the illumination light, whereby the means for varying the chirp of the illumination light is arranged in the illumination beam path and
directing the illumination light on an object being labelled with fluorescent markers.

17. The Method according to claim 16, further comprising the step of:
determining the power of the fluorescent light emanating from the object,
adjusting the chirp for maximizing the power of the fluorescent light emanating from the object.

18. The Method according to claim 16, further comprising the step of:
changing the chirp of the illumination light from positive chirp to negative chirp in an alternating fashion.
